(19) United States
(12) Patent Application Publication
(10) Pub. No.: US 2010/0031622 A1
(43) Pub. Date: Feb. 11, 2010

(54) SELF-SUPPORTING MERGER FOR MOWERS

(75) Inventor: Steven O. Frey, Elmira (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: Agway Manufacturing Inc., Elmira (CA)

(21) Appl. No.: 12/366,205

(22) Filed: Feb. 5, 2009

Related U.S. Application Data
(60) Provisional application No. 61/028,663, filed on Feb. 14, 2008.

(51) Int. Cl. A01D 57/30

(52) U.S. Cl. 56/366

(57) ABSTRACT

A self-supporting merger for use with a cutting machine for cutting plant material, the merger having a frame, a bed assembly mounted to the frame, a support assembly for supporting the weight of the merger, and a coupling assembly for coupling the frame to the cutting machine. The bed assembly is configured for receiving cut plant material discharged by the cutting machine, and includes a conveyor movable in at least one direction for displacing the cut plant material to at least one side of the merger. The bed assembly may be movably mounted to the frame, and be movable between an engaged position wherein the bed assembly is positioned to receive the cut plant material discharged by the cutting machine, and a bypass position wherein the cut plant material discharged by the cutting machine bypasses the bed assembly. The support assembly including at least one wheel coupled to the frame.

### RELATED APPLICATIONS

This application claims the benefit of U.S. Provisional Application Ser. No. 61/028,663, filed on Feb. 14, 2008 and entitled SELF-SUPPORTING MERGER FOR MOWERS, the entire contents of which are hereby incorporated by reference.

### FIELD

Disclosed herein are apparatus related to mowers, and in particular to mergers for use with mowers for cutting hay, crops and other plant material.

### BACKGROUND

Some prior art mergers are known. For example, U.S. Pat. No. 6,832,467 (Franet et al.) discloses a pull-type mower-conditioner with a windrow grouper mounted thereto by a frame that can be swung between a lowered working position and a raised non-working position. Similarly, U.S. Pat. No. 6,679,038 (Walch et al.) discloses a mower with a grouping device mounted thereto that allows plant material cut during two passes of the mower to be grouped together into a double windrow. However, these mergers are coupled to the mowers such that the mower carries the weight of each merger. This tends to cause increased strain on the mower and may make the mower more difficult to maneuver.

Other mergers may be towed separately behind a tractor. For example, U.S. Pat. No. 6,971,225 (Kempf et al.) discloses a merger for towing behind a vehicle that has a pickup assembly for picking up cut plant material from the ground, and a conveyor assembly for receiving the plant material and moving the plant material to one side of the merger. However, this type of merger requires the tractor to make two passes: a first pass with the mower to cut the plant material, and a second pass with the merger to pickup the plant material from the ground. Furthermore, the pickup head tends to pickup rocks and other undesirable materials when collecting the plant material, which can contaminate the plant material and make subsequent processing more difficult.

Accordingly, there is a need for improved mergers for use with cutting devices that overcome at least some of the known disadvantages.

### SUMMARY

According to one aspect of the invention, there is provided a self-supporting merger for use with a cutting machine for cutting plant material, comprising a frame, a bed assembly mounted to the frame and configured for receiving cut plant material discharged by the cutting machine, the bed assembly including a conveyor movable in at least one direction for displacing the cut plant material to at least one side of the merger, a support assembly for supporting the weight of the merger, the support assembly including at least one wheel coupled to the frame, and a coupling assembly for coupling the frame to the cutting machine.

The at least one wheel may include a pair of wheels, each wheel coupled to the frame via a pivoting assembly so that each wheel may pivot with respect to the frame about a generally vertical axis. The pivoting assemblies may be coupled to a walking bar configured to allow the wheels to pivot with respect to the frame about a generally horizontal axis. The at least one wheels may have a castor configuration such that each wheel trails the merger when the merger is moving.

In some embodiments, the bed assembly is movably mounted to the frame and is movable between an engaged position wherein the bed assembly is positioned to receive the cut plant material discharged by the cutting machine, and a bypass position wherein the cut plant material discharged by the cutting machine bypasses the bed assembly. The bed assembly may be moved between the engaged position and bypass position using a hydraulic assembly.

The merger may further comprise a hydraulic motor coupled to the conveyor and the hydraulic assembly, and wherein the hydraulic assembly is configured such that the hydraulic motor is driven when the bed assembly is in the engaged position and the hydraulic motor is not driven when the bed assembly is in the bypass position.

The hydraulic assembly may be configured to be controlled by a control lever movable between an active position in which the bed assembly is in the engaged position and an inactive position in which the bed assembly is in the bypass position.

The coupling assembly may include a mounting assembly configured to be secured to the cutting machine, and at least one mounting arm extending forwardly from the frame of the merger to engage with the mounting assembly. The at least one mounting arm may include a pair of spaced apart parallel mounting arms extending forwardly from the frame above the bed assembly and positioned so as not to interfere with the cut plant material on the bed assembly. The coupling assembly may includes at least one bracket configured to engage the at least one mounting arm.

According to another aspect of the invention, there is provided an apparatus for cutting and moving plant material, comprising a cutting machine configured to be coupled to a working vehicle, the cutting machine configured for cutting plant material and for discharging the cut plant material rearwardly therefrom, and self-supporting merger for coupling to the rear of the cutting machine, the merger having a frame, a bed assembly mounted to the frame, and a support assembly for supporting the weight of the merger, the support assembly including at least one wheel coupled to the frame, wherein the bed assembly is configured to receive the cut plant material and includes a movable conveyor for displacing the cut plant material to at least one side of the merger so as to form a windrow.

The at least one wheel may include a pair of wheels, each wheel coupled to a pivoting assembly and a walking bar, so that the wheels may pivot with respect to the frame about generally horizontal and vertical axes.

The bed assembly may be movably mounted to the frame and is movable between an engaged position wherein the bed assembly is positioned to receive the cut plant material discharged by the cutting machine, and a bypass position wherein the cut plant material discharged by the cutting machine bypasses the bed assembly.

According to yet another aspect of the invention, there is provided a self-supporting merger for use with a cutting machine for cutting plant material, comprising a frame, a bed assembly movably mounted to the frame, the bed assembly movable between an engaged position wherein the bed assembly is positioned to receive the cut plant material discharged by the cutting machine, and a bypass position wherein the cut plant material discharged by the cutting machine bypasses the bed assembly, a support assembly for supporting the weight of the merger, the support assembly including at least one wheel coupled to the frame, and a coupling assembly for coupling the frame to the cutting machine, wherein the bed assembly also including a conveyor configured to move when the bed assembly is in the engaged position so as to displace the cut plant material to one side of the merger.

The bed assembly may be moved between the engaged position and bypass position using a hydraulic assembly.

The merger may further comprise a hydraulic motor coupled to the conveyor and the hydraulic assembly, and wherein the hydraulic assembly is configured such that the hydraulic motor is driven when the bed assembly is in the engaged position and the hydraulic motor is not driven when the bed assembly is in the bypass position.

The hydraulic assembly may be configured to be controlled by a control lever movable between an active position in which the bed assembly is in the engaged position and an inactive position in which the bed assembly is in the bypass position.

The at least one wheel may include a pair of wheels, each wheel coupled to a pivoting assembly and a walking bar, so that the wheels may pivot with respect to the frame about generally horizontal and vertical axes.

The coupling assembly may include a mounting assembly configured to be secured to the cutting machine, and at a pair of spaced parallel mounting arms extending forwardly from the frame of the merger above the bed assembly and positioned so as not to interfere with the cut plant material on the bed assembly.

### BRIEF DESCRIPTION OF THE DRAWINGS

Examples will now be disclosed in particular reference to the following drawings, in which:

FIG. 1 is a front perspective view of a merger according to one embodiment of the invention;

FIG. 2 is a rear perspective view of the merger of FIG. 1 secured to a cutting machine;

FIG. 3 is another rear perspective view of the merger of FIG. 1;

FIG. 4 is a schematic diagram of a hydraulic assembly for the merger of FIG. 1 showing the bed assembly in an engaged position;

FIG. 5 is a schematic diagram of the hydraulic assembly of FIG. 4 showing the bed assembly in a bypass position;

FIG. 6 is a rear perspective view of the merger of FIG. 1 with the bed assembly in the engaged position and the belt conveyor moving cut plant material to form a windrow along one side of the merger; and

FIG. 7 is a rear perspective view of the merger of FIG. 6 with the bed assembly in the bypass position and cut plant material bypassing the merger to form a windrow behind the merger.

### DETAILED DESCRIPTION

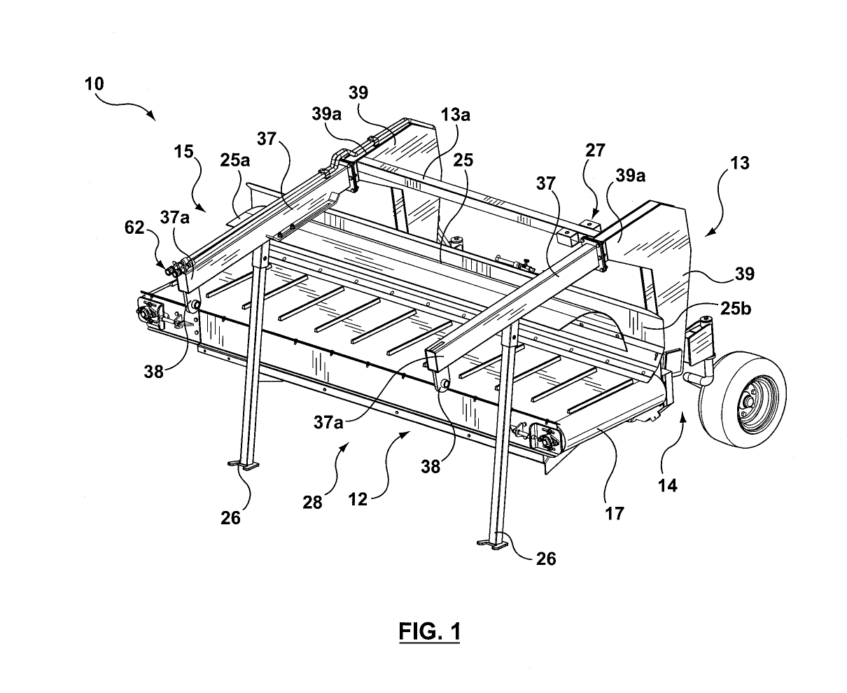

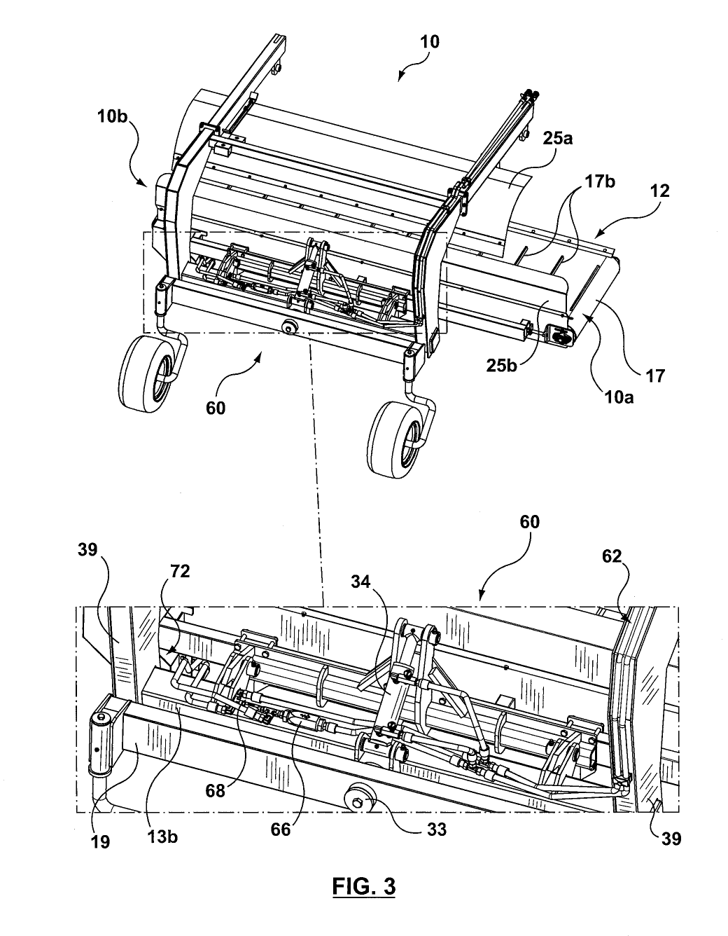

Referring generally to FIGS. 1 to 3, illustrated therein is a windrow merger 10 constructed according to one embodiment of the invention. The windrow merger 10 may be securely mounted to a cutting machine 8 (e.g. a mower-conditioner such as a Discbine® mower) that is towed behind a working vehicle 9 (e.g. a tractor).

The windrow merger 10 generally includes a bed assembly 12 mounted to a rigid chassis or frame 13. The bed assembly 12 is preferably mounted to the frame 13 such that the bed assembly 12 may be moved between an engaged position and a bypass position, as will be described in greater detail below.

The merger 10 also has a coupling assembly configured to releasably couple the merger 10 to the cutting machine 8.

The merger 10 also has a support assembly 14 coupled to the frame 13 for supporting the weight of the merger 10 such that the merger 10 is generally self-supporting. Accordingly, a substantial portion of the weight of the merger 10 is carried by the support assembly and is not carried by the cutting device 8.

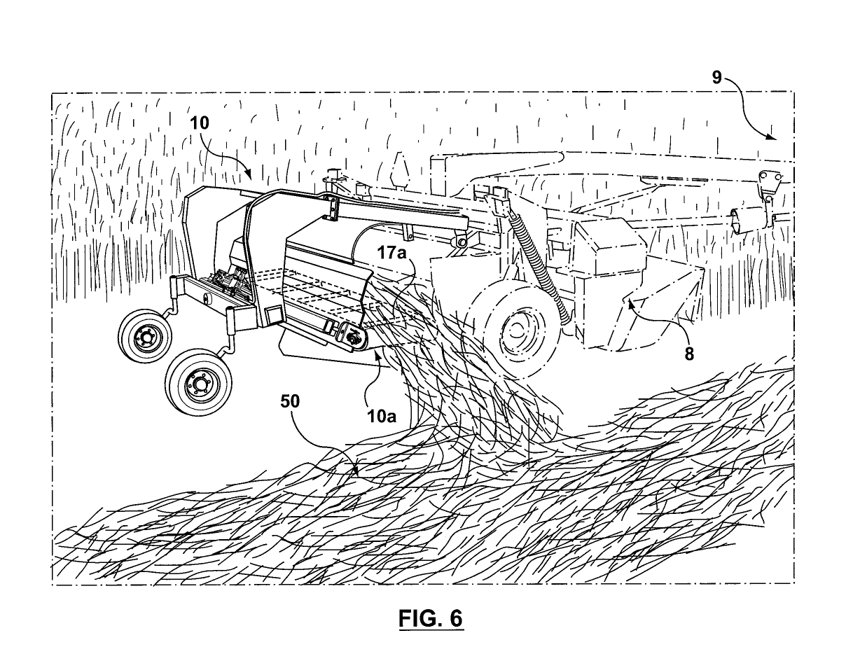

During use, the merger 10 is securely coupled to the cutting device 8, and both the merger 10 and cutting device 8 are towed by the working vehicle 9. As the cutting device 8 cuts plant material, the plant material is discharged rearwardly from the cutting device 8. When the bed assembly is in the engaged position, the discharged plant material may be received onto the bed assembly 12. Once on the bed assembly 12, the plant material may then be displaced to one side using a belt conveyor 17 so as to form a windrow 50 along one side 10a of the merger 10 (as shown in FIG. 6, for example).

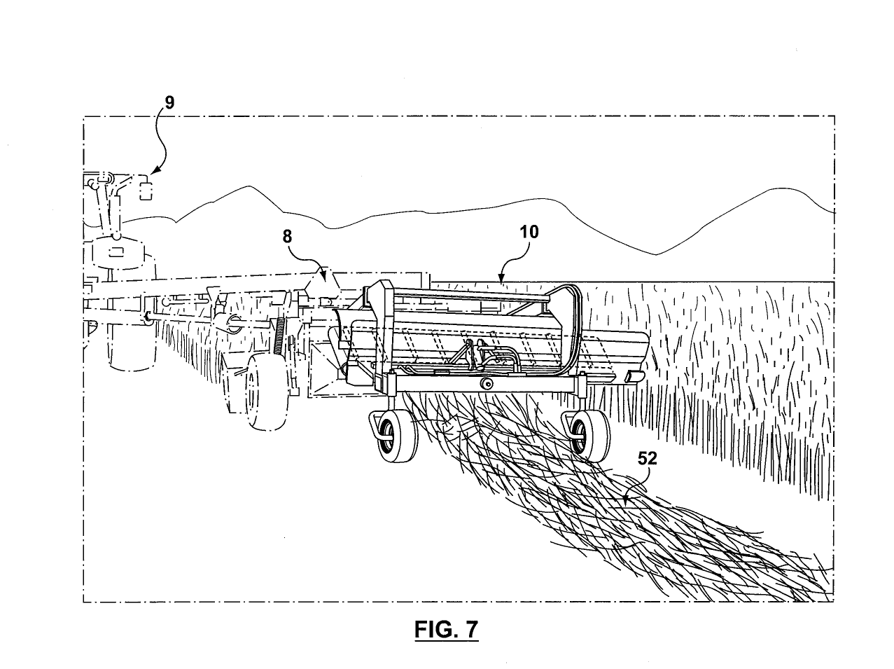

Alternatively, when the bed assembly 12 is in the bypass position, the plant material discharged by the cutting device 8 will bypasses the merger 10 and is deposited in a windrow 52 behind the merger 10 (as shown in FIG. 7, for example).

In some embodiments, the belt conveyor 17 may have lateral tabs 17b configured to facilitate the movement of the plant material.

In some embodiments, the merger 10 may include a shroud or cowling below the bed assembly 12 configured to assist in shaping the windrow 52.

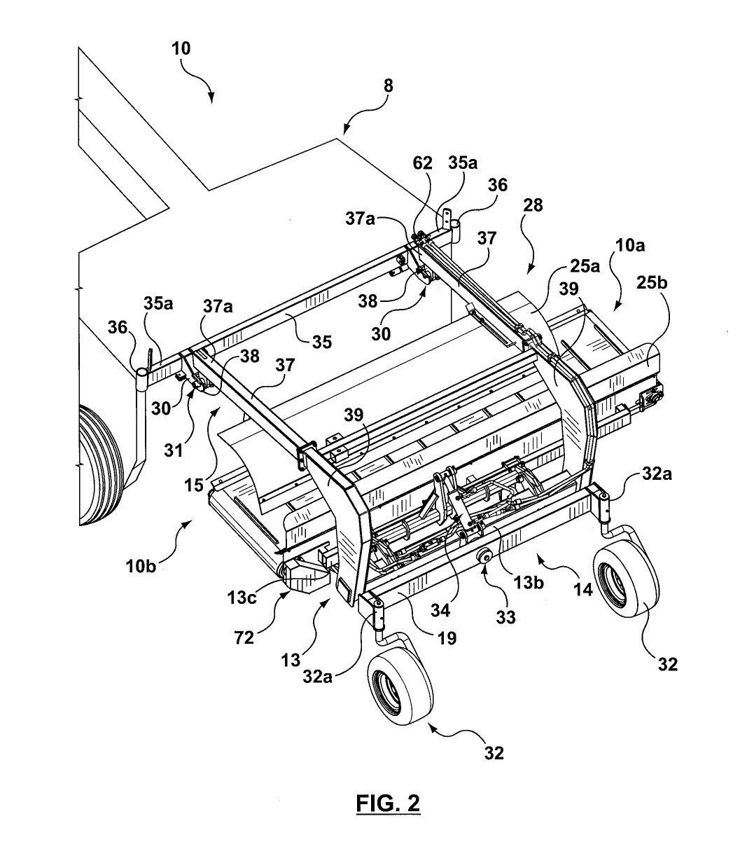

Turning now to FIGS. 1 and 2, the coupling assembly 15 may include at least one mounting arm 37 (e.g. a pair of spaced apart parallel mounting arms 37) that extend forwardly from the frame 13. Each mounting arm 37 may be supported by a base member 39 that extends upwardly to dispose the mounting arms 37 above the bed assembly 12. Accordingly, the mounting arms 37 will tend not to interfere with the movement of plant material during use of the merger 10. As shown, the upper ends 39a of the base members 39 may be secured together by a transverse frame member 13a so as to provide increased stability.

The coupling assembly 15 also includes a mounting assembly 29 configured to be secured to the cutting machine 8. As shown in FIG. 2, the mounting assembly 29 may include a transverse crossbar 35 having opposing ends 35a with coupling portions 36 (e.g. a collar or bracket) thereon. The coupling portions 36 are sized and shaped to engage with a portion of the frame of the cutting machine 8 (e.g. using bolts, pins, or other suitable fastening techniques).

The mounting assembly 29 may also have brackets 30 that extend rearwardly from the cross bar 35 (generally towards the merger 10). The brackets 30 may be generally U-shaped for receiving tabs 38 on the distal ends 37a of each mounting arm 37. The tabs 38 and brackets 30 can be joined together using any suitable fastener 31 (such as a pin or bolt), thus securing the merger 10 to the cutting machine 8.

In some embodiments, the coupling assembly 15 may allow the merger 10 to pivot vertically (and/or horizontally) with respect to the cutter 8 as the merger 10 and cutter 8 travel behind the tow vehicle 9. In this manner, additional stresses that might be imparted onto the cutting device 8 due to the movement of the merger 10 may be reduced or even eliminated.

Alternatively, in other embodiments the coupling assembly 15 may rigidly couple the merger 10 to the cutting machine 8 such that little or no relative movement may be permitted.

In some embodiments, the mounting assembly 29 may be customized for cutting machines 8 of different shapes and configurations, but with common location points for the brackets 30 so that the merger 10 may be coupled to different cutting machines 8 without modification to the mounting arms 37.

Turning again to FIG. 2, as described above the merger 10 includes a support assembly 14 for supporting the weight of the merger 10. For example, as shown the support assembly 14 may include one or more wheels 32 for supporting the weight of the merger 10. Each wheel 32 may be coupled to the frame 13 via a pivoting assembly 32a such that each wheel is may freely pivot about a generally vertical axis with respect to the frame 13.

The wheels 32 may also have a castor configuration such that the wheels 32 will tend to trail the merger 10 as the merger 10 moves forwardly. The castor configuration tends to keep the wheels 32 aligned with the direction of travel of the merger 10 even when the merger 10 is turning.

In some embodiments, the wheels 32 may be coupled to the frame 13 using a suspension system so as to provide for smoother handling. For example, the wheels 32 may be secured to a rocker assembly or walking bar 19.

The walking bar 19 may be pivotally coupled to the frame 13 via a pivoting joint 33 provided on a rear transverse member 13b of the frame 13. In this manner, the walking bar 19 may rock or pivot back and forth about a generally horizontal axis while the merger 10 is pulled forward in response to the ground conditions encountered by the wheels 32, thus providing for smoother movement of the merger 10.

In other embodiments, the support assembly 14 may include a more sophisticated suspension components coupled to the wheels 32. For example, the support assembly 14 may include a spring assembly (e.g. a coil spring or a leaf spring) and/or a damper assembly coupled to the wheels 32.

In some embodiments, the wheels 32 may be configured to support at least 50% of the weight of the merger 10, with the remaining load being transferred through the mounting arms 37 to the cutting device 8. In other examples, at least 75% of the weight of the merger 10 may be carried by the wheels 32. In yet other embodiments, at least 90% of the weight of the merger 10 may be carried by the wheels 32.

As shown in FIGS. 1 and 2, the merger 10 may also include a deflector assembly 25 coupled thereto and provided generally above the bed assembly 12. The deflector assembly 25 is generally configured so as to inhibit cut plant material discharged from the cutting machine 8 and received onto the bed assembly 12 from falling rearwardly off of the bed assembly 12.

As shown, the deflector assembly 25 may include an upper shield 25a (which may be coupled to the mounting arms 37) and a lower shield 25b (which may be coupled to the bed assembly by an intermediate transverse member 13c of the frame 13). In some embodiments, the lower shield 25b will be raised or lowered along with the bed assembly 12.

Turning now to FIGS. 6 and 7, as briefly described above, the bed assembly 12 may generally be moved from an engaged (or lowered) position or a bypass (or raised) position.

As shown in FIG. 6, when the bed assembly 12 is in the engaged or lowered position, incoming plant material that has been discharged by the cutting machine 8 is received onto the belt conveyor 17 of the bed assembly 12. The deflector assembly 25 helps to inhibit the plant material from falling rearwardly off of the bed assembly 12. The belt conveyor 17 then moves the plant material towards one of the ends 17a of the belt conveyor 17, discharging the plant material along the side 10a of the merger 10 so as to form the windrow 50.

Alternatively, when the bed assembly 12 is moved to the raised or bypass position (as shown in FIG. 7), the plant material cut by the cutting machine 8 will be discharged beneath the bed assembly 12 and the belt conveyor 17, thus bypassing the merger 10 and forming a windrow 52 behind the merger 10.

In some embodiments, the bed assembly 12 may be configured to engage one or more hard stops when in either or both of the engaged position and the bypass position.

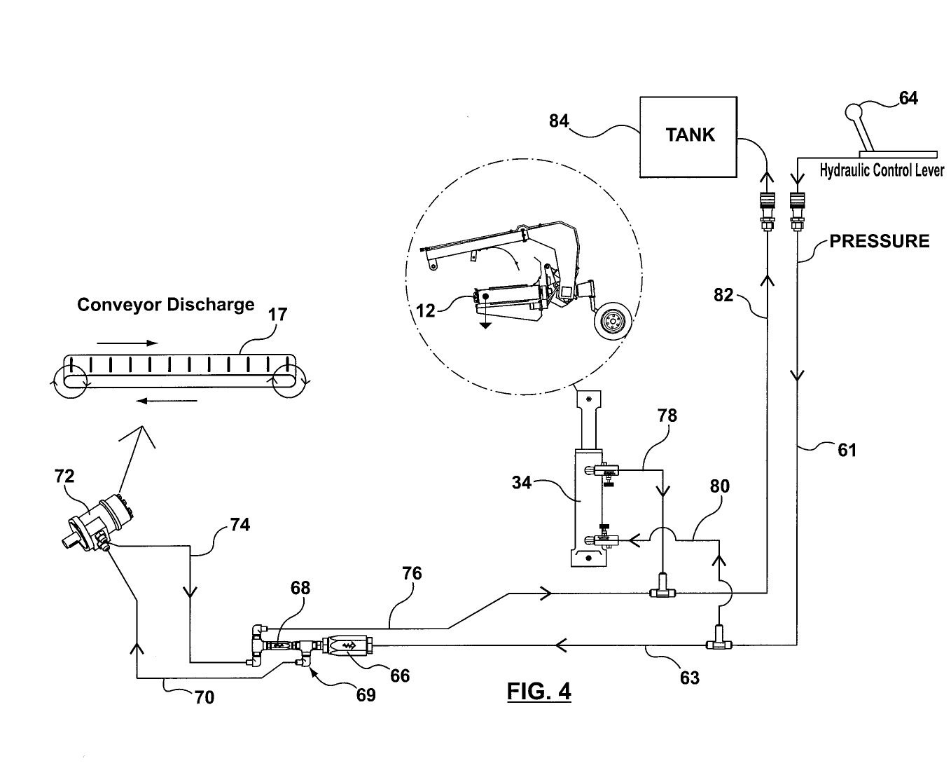

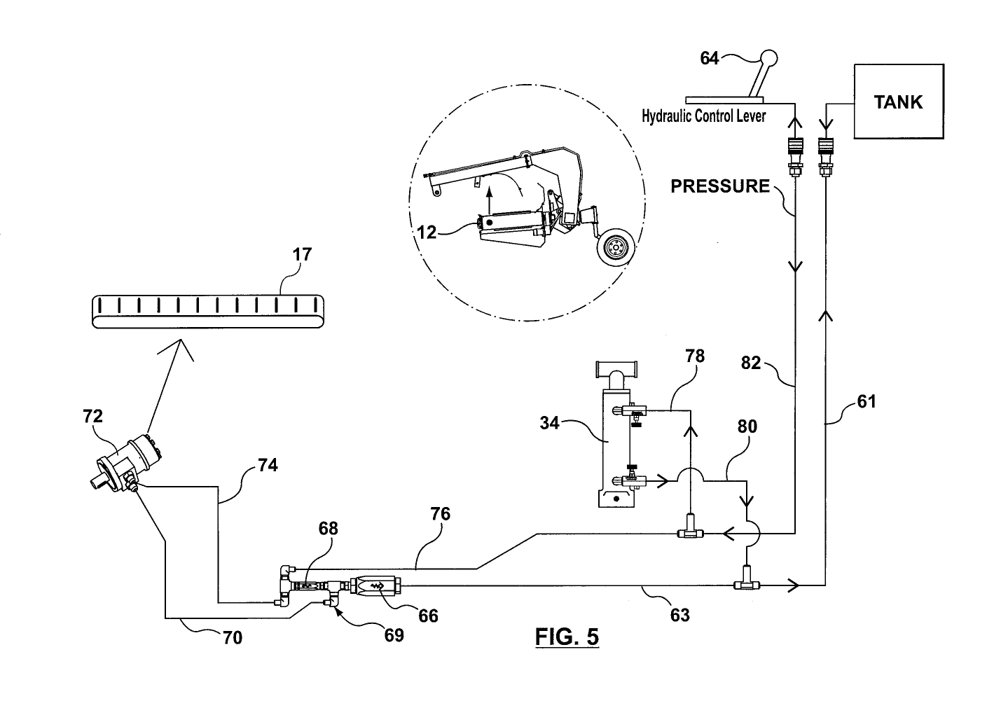

Referring now generally to FIGS. 4 and 5, the merger 10 may include a hydraulic assembly 60 for powering the belt conveyor 17 and/or for raising and lowering the bed assembly 12. In some embodiments, the hydraulic assembly 60 may be coupled to a hydraulic power source (not shown) on the working vehicle 9 which can be coupled to the hydraulic assembly 60 on the merger 10 using hydraulic supply lines 62.

The hydraulic assembly 60 includes at least one hydraulic flow control lever 64 that controls two the movement of the belt conveyor 17 and the position of the bed assembly 12 with respect to the frame 13. The control lever 64 is preferably provided in an operator compartment (not shown) on the tow vehicle 9, allowing the operator of the working vehicle to control the hydraulic assembly 60.

As shown, in some embodiments, the hydraulic functions of the merger 10 may be controlled using a single lever 64 to control the direction of hydraulic pressure. The lever 64 may be movable between two positions: an active position, wherein the hydraulic motor 72 is powered to drive the belt 17 and the bed 12 is lowered into the engaged position, and an inactive position, wherein the motor 72 may be generally inactive and the bed 12 is raised to the bypass position.

FIG. 4 shows a schematic of the hydraulic assembly 60 operating in the active mode. As shown, pressurized hydraulic oil enters the hydraulic assembly 60 through a first hydraulic line 61, which feeds into the first feed line 80 of the hydraulic cylinder 34, causing the cylinder 34 to extend (and lowering the bed assembly 12).

Pressurized oil in the first hydraulic line 61 then passes into a second hydraulic line 63 that generally feeds the hydraulic motor 72. As shown, the pressurized hydraulic fluid passes from the second hydraulic line 63 through a first one-way check valve 66.

Oil is inhibited from pass through a second one-way check valve 68, and thus flows through a T-coupling 69 into a third hydraulic line 70. The third hydraulic line 70 is coupled to and pressurizes the hydraulic motor 72, causing the motor 72 to turn and thus moving the belt conveyor 17.

After leaving the motor 72, the hydraulic fluid (now at a reduced pressure) flows into a fourth hydraulic line 74. Since the pressure in line 63 is greater than the pressure in line 74, the second one-way check valve 68 remains closed, and the hydraulic fluid flows from the fourth line 74 into a fifth line 76.

Oil then continues through fifth line 76, and is joined with oil from the second feed line 78 of the cylinder 34. The oil then proceeds along a sixth hydraulic line 82 and returns to a storage tank 84, which may be mounted (not shown) on the tow vehicle 9.

With the hydraulic lever 64 in this active orientation, the bed assembly 12 is moved to the lowered position with the cylinder 34 extended, while the hydraulic motor 72 drives the belt 17 to move the crop to one side of the merger 10 (as shown in FIG. 6).

Turning now to FIG. 5, the hydraulic lever 64 is shown in the inactive mode, with the hydraulic flow generally reversed in the lines. As shown, pressurized oil flows through the sixth hydraulic line 82, passing into the second feed line 78 of the hydraulic cylinder 34, causing the cylinder to retract (and thus raising the bed assembly 12).

The pressurized oil then continues through the fifth hydraulic line 76, and pressurizes the fourth hydraulic line 74 and the third hydraulic line 70. The oil may also flow through the second one-way check valve 68, however it is generally not able to pass through the first one-way check valve 66. Accordingly, the hydraulic circuit formed by the lines 70, 74 and motor 72 becomes stalled (e.g. flow of hydraulic fluid is generally inhibited). The oil eventually comes to rest within the lines 70, 74, and 76, bringing the hydraulic motor 72 and the belt 17 to a stop.

The second check valve 68 is configured to allow some oil to re-circulate within the lines 70 and 74 when the lever 64 moves from the active mode to the inactive mode, so that the hydraulic motor 72 is generally stopped gently so as to inhibit damaging the motor 72.

As the cylinder 34 is retracted by the pressurized oil in the second feed line 78, oil on the other side of the cylinder 34 can return through the first feed line 80 and into the first and second hydraulic lines 61, 63. Since the pressure in lines 70 and 74 is generally greater than the pressure in the second hydraulic line 63, the first check valve 66 generally inhibits fluid in the second hydraulic line 63 from passing therethrough. Accordingly, the fluid flowing through the first feed line 80 of the hydraulic cylinder 34 can return to the tank 84 via the first hydraulic line 61.

With the bed assembly 12 is in the bypass position, cut plant material discharged by the cutting device 8 will pass below the bed assembly 12, thus bypassing the merger 10 and coming to rest on the ground as a windrow 52 behind the merger 10 (as shown in FIG. 7).

While the belt conveyor 17 described herein is configured for moving the cut plant material to the one side 10a of the merger 10, it will be understood that in some embodiments the belt conveyor 17 could be driven in two directions such that the vegetation could be displaced onto either side 10a or 10b of the merger 10.

In some examples, the merger 10 may be provided with removable mounting stands 26. The mounting stands 26 may be used to support the merger 10 during storage (e.g. when the merger 10 is decoupled from the cutting device 8). In some embodiments, the mounting stands 26 may be stored in one or more stand receivers 27 on the frame 13 when the merger 10 is in use.

While the above description includes a number of exemplary embodiments, many modifications, substitutions, changes and equivalents will now occur to those of ordinary skill in the art.

1. A self-supporting merger for use with a cutting machine for cutting plant material, comprising:
(a) a frame;
(b) a bed assembly mounted to the frame and configured for receiving cut plant material discharged by the cutting machine, the bed assembly including a conveyor movable in at least one direction for displacing the cut plant material to at least one side of the merger;
(c) a support assembly for supporting the weight of the merger, the support assembly including at least one wheel coupled to the frame; and
(d) a coupling assembly for coupling the frame to the cutting machine.

2. The merger of claim 1, wherein the at least one wheel includes a pair of wheels, each wheel coupled to the frame via a pivoting assembly so that each wheel may pivot with respect to the frame about a generally vertical axis.

3. The merger of claim 2, wherein the pivoting assemblies are coupled to a walking bar configured to allow the wheels to pivot with respect to the frame about a generally horizontal axis.

4. The merger of claim 1, wherein the at least one wheels have a castor configuration such that each wheel trails the merger when the merger is moving.

5. The merger of claim 1, wherein the bed assembly is movably mounted to the frame and is movable between an engaged position wherein the bed assembly is positioned to receive the cut plant material discharged by the cutting machine, and a bypass position wherein the cut plant material discharged by the cutting machine bypasses the bed assembly.

6. The merger of claim 5, wherein the bed assembly may be moved between the engaged position and bypass position using a hydraulic assembly.

7. The merger of claim 6, further comprising a hydraulic motor coupled to the conveyor and the hydraulic assembly, and wherein the hydraulic assembly is configured such that the hydraulic motor is driven when the bed assembly is in the engaged position and the hydraulic motor is not driven when the bed assembly is in the bypass position.

8. The merger of claim 7, wherein the hydraulic assembly is configured to be controlled by a control lever movable between an active position in which the bed assembly is in the engaged position and an inactive position in which the bed assembly is in the bypass position.

9. The merger of claim 1, wherein the coupling assembly includes a mounting assembly configured to be secured to the cutting machine, and at least one mounting arm extending forwardly from the frame of the merger to engage with the mounting assembly.

10. The merger of claim 9, wherein the at least one mounting arm includes a pair of spaced apart parallel mounting arms extending forwardly from the frame above the bed assembly and positioned so as not to interfere with the cut plant material on the bed assembly.

11. The merger of claim 1, wherein the coupling assembly includes at least one bracket configured to engage the at least one mounting arm.

12. An apparatus for cutting and moving plant material, comprising:
(a) a cutting machine configured to be coupled to a working vehicle, the cutting machine configured for cutting plant material and for discharging the cut plant material rearwardly therefrom; and
(b) self-supporting merger for coupling to the rear of the cutting machine, the merger having a frame, a bed assembly mounted to the frame, and a support assembly for supporting the weight of the merger, the support assembly including at least one wheel coupled to the frame;
(c) wherein the bed assembly is configured to receive the cut plant material and includes a movable conveyor for displacing the cut plant material to at least one side of the merger so as to form a windrow.

13. The apparatus of claim 12, wherein the at least one wheel includes a pair of wheels, each wheel coupled to a pivoting assembly and a walking bar, so that the wheels may pivot with respect to the frame about generally horizontal and vertical axes.

14. The apparatus of claim 12, wherein the bed assembly is movably mounted to the frame and is movable between an engaged position wherein the bed assembly is positioned to receive the cut plant material discharged by the cutting machine, and a bypass position wherein the cut plant material discharged by the cutting machine bypasses the bed assembly.

15. A self-supporting merger for use with a cutting machine for cutting plant material, comprising:
(a) a frame;
(b) a bed assembly movably mounted to the frame, the bed assembly movable between an engaged position wherein the bed assembly is positioned to receive the cut plant material discharged by the cutting machine, and a bypass position wherein the cut plant material discharged by the cutting machine bypasses the bed assembly;
(c) a support assembly for supporting the weight of the merger, the support assembly including at least one wheel coupled to the frame; and
(d) a coupling assembly for coupling the frame to the cutting machine;
(e) wherein the bed assembly also including a conveyor configured to move when the bed assembly is in the engaged position so as to displace the cut plant material to one side of the merger.

16. The merger of claim 15, wherein the bed assembly may be moved between the engaged position and bypass position using a hydraulic assembly.

17. The merger of claim 16, further comprising a hydraulic motor coupled to the conveyor and the hydraulic assembly, and wherein the hydraulic assembly is configured such that the hydraulic motor is driven when the bed assembly is in the engaged position and the hydraulic motor is not driven when the bed assembly is in the bypass position.

18. The merger of claim 17, wherein the hydraulic assembly is configured to be controlled by a control lever movable between an active position in which the bed assembly is in the engaged position and an inactive position in which the bed assembly is in the bypass position.

19. The merger of claim 15, wherein the at least one wheel includes a pair of wheels, each wheel coupled to a pivoting assembly and a walking bar, so that the wheels may pivot with respect to the frame about generally horizontal and vertical axes.

20. The merger of claim 15, wherein the coupling assembly includes a mounting assembly configured to be secured to the cutting machine, and at a pair of spaced parallel mounting arms extending forwardly from the frame of the merger above the bed assembly and positioned so as not to interfere with the cut plant material on the bed assembly.
